(19) United States
(12) Patent Application Publication
(10) Pub. No.: US 2020/0083560 A1
(43) Pub. Date: Mar. 12, 2020

(54) FLEXIBLE LITHIUM-ION BATTERY

(71) Applicants: HONDA MOTOR CO., LTD., Tokyo (JP); NANOSYNTHESIS PLUS, LTD., Columbus, OH (US)

(72) Inventors: Avetik R. HARUTYUNYAN, Santa Clara, CA (US); Oleg A. KUZNETSOV, San Jose, CA (US); Elena Mora PIGOS, Galena, OH (US)

(21) Appl. No.: 16/560,731

(22) Filed: Sep. 4, 2019

Related U.S. Application Data
(60) Provisional application No. 62/727,922, filed on Sep. 6, 2018.

(51) Int. Cl. H01M 10/0525; H01M 10/04; H01M 4/133; H01M 4/134; H01M 2/14

(52) U.S. Cl. CPC H01M 10/0525; H01M 10/0431; H01M 2/14; H01M 4/134; H01M 4/133

(57) ABSTRACT

The present disclosure relates to flexible batteries made of one or more self-standing flexible anodes and cathodes. The flexible batteries are free of binder, wherein the output of the batteries is substantially the same when bent, rolled, or folded compared to the output when flat.

### CROSS-REFERENCE TO RELATED APPLICATIONS

This application claims priority to U.S. Provisional Application No. 62/727,922 filed Sep. 6, 2018, entitled “Flexible Lithium-Ion Battery”, which is hereby incorporated by reference herein in its entirety.

### JOINT RESEARCH AGREEMENT

The presently claimed invention was made by or on behalf of the below listed parties to a joint research agreement. The joint research agreement was in effect on or before the date the claimed invention was made, and the claimed invention was made as a result of activities undertaken within the scope of the joint research agreement. The parties to the joint research agreement are 1) Honda Research Institute USA, Inc.; and 2) NanoSynthesis Plus, Ltd.

### BACKGROUND

With recent intense developments of wearable devices, healthcare, cosmetics, wearable medical sensors and drug delivery devices, portable electronics, smart packaging, and RFID, among other applications, the development of thin, flexible batteries with high energy density is becoming an essential challenge for providing proper power to the respective devices. Depending on the device, these batteries should provide the potential not only proper for current electronics (V-range), but also possess energy from μWh up to kWh to cover a broad range of applications. However, these new applications, apart from electrical parameters, also require the batteries to be flexible, thin, stretchable, rollable, bendable, and foldable, and to cover micro- and large areas. These features are hard to achieve in typical battery design, where electrodes are printed on current collectors, such as metal foils; and for batteries encapsulated into rigid enclosures, such as coin, cylindrical or prismatic cells. Hence, there is a need for new design and materials for batteries powering this fast-emerging field of wearable devices.

### SUMMARY

The present disclosure relates to batteries, and more particularly to batteries made of flexible materials. In some variations, the present disclosure is directed to a flexible lithium ion battery comprising: a flexible anode comprising composite material comprising anode active material (graphite, silicon, any porous material that will match the voltage of the given cathode material, natural graphite, artificial graphite, activated carbon, carbon black, high-performance powdered graphene. etc.) particles with a size range from 1 nanometer to larger, in a three-dimensional cross-linked network of carbon nanotubes; a flexible cathode comprising composite material comprising cathode active material (lithium metal oxide, metal lithium, etc.) particles in a three-dimensional cross-linked network of carbon nanotubes; and a flexible separator membrane positioned between the anode and the cathode, the flexible separator membrane characterized by a length, a width, a thickness, and at least one edge; wherein the battery is packed in a pouch cell.

In some aspects, the battery is free of current collector and is assembled by placing the separator membrane between a fully prepared anode and a fully prepared cathode without further pressing.

In some aspects, the battery is free of current collector and is assembled by placing a separator between a pre-pressed anode and a pre-pressed cathode, optionally attached to a tab, and optionally containing an embedded tab attachment, and pressing together.

In some aspects, the battery is free of current collector and is assembled by placing the separator membrane between un-pressed anode and un-pressed cathode, wherein the anode and cathode each independently optionally includes an embedded battery tab attachment, and then pressing the assembled anode, separator and cathode.

In some aspects, the battery is free of current collector and is assembled by placing the separator membrane between an un-pressed first electrode and a pre-pressed second electrode, and then pressing the assembled anode, separator and cathode.

In some aspects, the concentration of carbon nanotubes on a surface of a respective electrode facing the separator is higher (5-100 wt % of nanotubes), than that in the bulk of the electrodes (0.5-10 wt % of nanotubes), while the concentration of the carbon nanotubes on surfaces of the respective electrode facing away from the separator will be lower (0-1 wt % of nanotubes) than that in the bulk of the respective electrode, and the battery is free of current collector.

In some aspects, the total thickness of the electrodes is reduced by pressing, from 1.1 to 5 times, and the battery is free of current collector.

In some aspects, one or more electrodes further comprise a battery tab attached to at least one of a respective protrusion extending from a main body of the electrode past the separator, or to the main body of the electrode at cutouts of the separator membrane and the opposing electrode, and the battery is free of current collector.

In some aspects, the battery further comprises one or more embedded battery tab attachments, each extending from a respective electrode past the edge of the separator membrane and some of them extending outside the pouch cell, and the battery is free of current collector. In multi-cell configurations tab attachments from multiple anodes are typically welded together and to a single tab inside of the cell packaging, and only this single tab goes outside of the cell packaging. The same is done for multiple cathodes.

In some aspects, the battery tab extends past the pouch cell to deliver a current outside the battery, and the battery is free of current collector.

In some aspects, the pouch cell is a polymer pouch cell, and the battery is free of current collector.

In some aspects, the battery is in a single-cell configuration, and the battery is free of current collector.

In some aspects, the battery is in a multi-cell configuration, and the battery is free of current collector.

In some aspects, the battery further comprises a liquid, gel or solid electrolyte, and the battery is free of current collector.

In some aspects (such as shown in FIGS. 3A-3B), one or more electrodes are in contact with separator membranes on both faces of the one or more electrodes, wherein both faces of the one or more electrodes exhibit an increased nanotube content relative to that in the bulk of the one or more electrodes, and the battery is free of current collector. This arrangement may exist in either a single cell configuration or a multi-cell configuration, and the extra layers of the separator membrane can be added on the outside of the cell (FIG. 3A) to improve the cell mechanical integrity, and to allow the cell to slide easier in respect to the packaging during bending, twisting, or similar motions. It is believed that such extra layers will hold the electrode material together, and prevent or reduce “washing out” of the active material particles from the electrode. In the inner electrodes of the multi-cell configuration, this arrangement will be always present. Cells with a separator membrane attached on both outer sides may also be easier to handle during the battery assembly/encapsulation.

In some aspects, the cell assembly is encapsulated either flat, or folded one or more times prior to encapsulation into the pouch cell, and the battery is free of current collector.

### BRIEF DESCRIPTION OF THE DRAWINGS

FIGS. 1A and 1B show schematic views of single-cell (FIG. 1A) and multi-cell (FIG. 1B) configurations of batteries according to some aspects of the present disclosure.

FIGS. 2A-2D show a pouch battery according to some aspects of the present disclosure connected to an LED device, with the pouch battery in both flat (FIGS. 2A-2B) and rolled (FIGS. 2C-2D) configurations, shown both schematically (FIGS. 2A and 2C) and as photographs (FIGS. 2B and 2D).

FIGS. 3A and 3B show schematic views of single-cell (FIG. 3A) and multi-cell (FIG. 3B) configurations of batteries according to other aspects of the present disclosure.

FIGS. 4A and 4B show schematic cross-sections of the preferred electrode layer structure, according to some aspects of the present disclosure, with separator membrane on both sides (FIG. 4A) or only one side (FIG. 4B).

FIG. 5 shows a battery according to some aspects of the present disclosure in a folded configuration.

FIG. 6 shows a preferred flexible self-standing electrode stacking scheme for some examples of multi-cell and folded embodiments, according to some aspects of the present disclosure.

FIG. 7 shows a preferred flexible self-standing electrode stacking scheme for some examples of multi-cell and folded embodiments, according to some aspects of the present disclosure.

### DETAILED DESCRIPTION

The present disclosure is directed to a flexible lithium ion battery comprising a flexible anode comprising composite material comprising anode active material (graphite, silicon, etc.) particles in a three-dimensional cross-linked network of carbon nanotubes; a flexible cathode comprising composite material comprising cathode active material (lithium metal oxide, metal lithium, etc.) particles in a three-dimensional cross-linked network of carbon nanotubes; and a separator positioned between the anode and the cathode. According to some aspects, a three-dimensional cross-linked network of carbon nanotubes can have a webbed morphology, a non-woven, non-regular, or non-systematic morphology, or combinations thereof. In some aspects, the battery is free of current collector. In some aspects, the cathode, the anode, and the separator are packed in a pouch cell. This pouch cell enclosure is suitably flexible. In some aspects, the pouch cell may be a polymer pouch cell.

The electrodes in the battery are not supported by current collector foils, such as aluminum for the cathode or copper for the anode, and do not contain binder, which can crumble or flake off. Instead, the electrodes are self-standing. Without wishing to be bound to any particular theory, the presence a plurality of carbon nanotubes in carbon nanotube webs renders the electrodes self-standing and flexible; and the flexible electrodes give rise to a flexible battery. When connected to LEDs, batteries according to the present disclosure successfully operate under a broad range of bending, rolling, and folding (at angles less than or greater than 180°) along various battery axes, in a rectangular pouch cell.

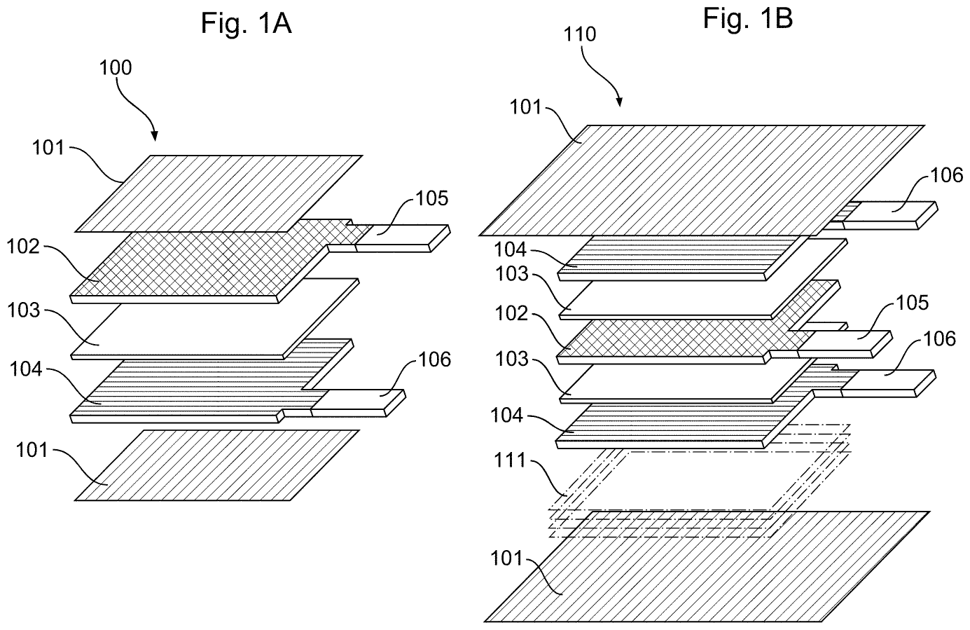

Current collectors in lithium ion batteries are for example, a copper foil in the anode or an aluminum foil in the cathode, both of which work as an electrical conductor between the electrode and external circuits as well as a support for a coating of the electrode materials on the current collector, which can span the length and width of the electrode. Breakup of the metallic foil and detachment of the active materials from the current collector are problems for flexible electrodes and flexible batteries. As used herein, “free of current collector” refers to a battery or electrode that is free of metal or foil current collector. It should be understood that battery tabs attached to the electrodes are not current collectors, as the battery tabs shown as non-limiting examples in FIGS. 1A-1B, 3A-3B, and 5. As used herein, an electrode that is “flexible” is able to be bent without cracking or breaking. As will be known to those of ordinary skill in the art, flexibility may depend on one or more chemical and/or material factors, including but not limited to composition and degree of compression.

As used herein, the term “about” is defined to being close to as understood by one of ordinary skill in the art. In one non-limiting embodiment, the term “about” is defined to be within 10%, preferably within 5%, more preferably within 1%, and most preferably within 0.5%.

In addition, the thickness of the binderless, collectorless self-standing electrode may be modified by pressing, which may reduce the overall thickness by as much as 5 times, such as by about 4 times, by about 3 times, by about half, by about 1.5 times, by about 1.1 times, or any range in between. For example, a binderless, collectorless self-standing electrode with a thickness of 100 micrometers may be pressed to a thickness of 50 micrometers (i.e., reduced overall thickness by half), or a binderless, collectorless self-standing electrode with a thickness of 500 micrometers may be pressed to a thickness of 100 micrometers (i.e., reduced overall thickness by 5 times). In some aspects, pressing reduces overall thickness by half. In some aspects, pressing reduces overall thickness by about 1.1 to by about 5 times. In some aspects, pressing reduces overall thickness by about 1.5 times to by about 3 times. The optimal degree and/or limits of pressing for a given material can be determined by persons of ordinary skill in the art. Suitably, pressing does not substantially destroy active material particles/flakes, i.e., as a general guidance, not more than 25% of the particles or flakes are damaged. The exact percentage of the acceptable particle damage may vary for different active materials and for different formulations of the electrode composites, and need to be determined in each case by those of ordinary skill in the art. For batteries with liquid or gel electrolytes, suitably, enough voids remain in the material after pressing for efficient electrolyte access, i.e., at least 50% of the surface (preferably, 100% of the surface) of each particle or flake of the active material is wetted by the electrolyte. A non-limiting example of a liquid electrolyte is LP71 electrolyte (1M LiPF₆ in ethylene carbonate/diethyl carbonate/dimethyl carbonate, 1:1:1 mixture by volume). Additionally, the voids are suitably still interconnected after pressing, i.e., no trapped inaccessible voids. As a general guideline, the density of the pressed material should suitably be below the bulk density of the active material powder (not the density of the active material, which is higher; e.g., for NMC powder, Lithium Nickel Manganese Cobalt Oxide powder, the bulk density is ca. 2.35 g/cm³, while the density of NMC itself is >3.5 g/cm³). Pressing electrode material to a density approaching or exceeding the bulk density of the active material powder, can lead to electrode material that may crack easily and no longer be flexible. It should be understood that the features of the external packaging material, for example flexibility, twistability, wearability, are independent of the electrode material, for example, contained within the external packaging.

Pressing may improve flexibility, mechanical strength, and/or electrolyte accessibility in batteries according to aspects of the present disclosure. Pressing also modifies the density of the electrode. Suitable methods and apparatuses for pressing electrodes are known in the art are included but are not limited to those disclosed in U.S. patent application Ser. No. 15/665,171, entitled “Self Standing Electrodes and Methods for Making Thereof,” filed Jul. 31, 2017, which is hereby incorporated by reference herein in its entirety. According to aspects of the present disclosure, individual electrodes may be pressed, or entire assemblies of multiple electrodes separated by separators may be collectively pressed, with or without the pouch cell present. In some aspects, pressing reduces overall thickness about 1.1 to about 5 times. In some aspects, pressing reduces overall thickness about 1.5 times to about 3 times.

As is known to those of ordinary skill in the art, pressing or compression may improve electrical and/or mechanical contact between the battery tab and the composite, and it may also make the composite mechanically stronger. However, too much compression or pressing can hinder electrolyte access to the inner parts of the electrode, and complicate the movement of lithium ions in and out of the electrode, thereby worsening battery dynamic characteristics. Too much compression may also lead to rigid and brittle electrodes, easily forming cracks and disintegrating; this can either reduce the battery capacity, or destroy it completely. Alternatively, too little compression may not provide enough cross-linking of nanotube networks leading to mechanically weak electrode material, insufficient electrical contacts within the material (and, thus, lower electrical conductivity of the material and inefficient current collection from the active material particles), and/or incomplete mechanical trapping of the active material particles within the nanotube network (they can be washed-out by the electrolyte). Insufficient pressing may also result in thicker electrodes, requiring more electrolyte to completely wet them, therefore reducing the energy storage density of the battery. In addition, excessive pressing may cause punctures in the separator membrane; which is not a desirable outcome. In addition, it may be desirable to regulate the distance between the rolls or rollers in a rolling press or calendaring machine, or between the plates of a platen press. It is within the knowledge of those of ordinary skill in the art to determine optimal pressing thickness based on the properties desired in the electrode. Suitable apparatuses for pressing electrodes and/or batteries of the present disclosure include, but are not limited to, roller mills and hydraulic presses.

As used herein, “electrode active material” refers to the material hosting Lithium in an electrode. The term “electrode” refers to an electrical conductor where ions and electrons are exchanged with an electrolyte and an outer circuit. “Positive electrode” and “cathode” are used synonymously in the present description and refer to the electrode having the higher electrode potential in an electrochemical cell (i.e. higher than the negative electrode). “Negative electrode” and “anode” are used synonymously in the present description and refer to the electrode having the lower electrode potential in an electrochemical cell (i.e. lower than the positive electrode). Cathodic reduction refers to a gain of electron(s) of a chemical species, and anodic oxidation refers to the loss of electron(s) of a chemical species.

Metals in lithium metal oxides according to the present disclosure may include but are not limited to one or more alkali metals, alkaline earth metals, transition metals, aluminum, or post-transition metals, and hydrates thereof. Non-limiting examples of lithium metal oxides include lithiated oxides of Ni, Mn, Co, Al, Mg, Ti, and any mixture thereof. In an illustrative example, the lithium metal oxide is lithium nickel manganese cobalt oxide (LiNiₓMn_{y}Co_{z}O₂, x+y+z=1), Li(Ni,Mn,Co)O₂, or Li—Ni—Mn—Co—O. The lithium metal oxide powders can have a particle size defined within a range between about 1 nanometer and about 100 microns, or any integer or subrange in between. In a non-limiting example, the lithium metal oxide particles have an average particle size of about 1 μm to about 10 μm.

“Alkali metals” are metals in Group I of the periodic table of the elements, such as lithium, sodium, potassium, rubidium, cesium, or francium.

“Alkaline earth metals” are metals in Group II of the periodic table of the elements, such as beryllium, magnesium, calcium, strontium, barium, or radium.

“Transition metals” are metals in the d-block of the periodic table of the elements, including the lanthanide and actinide series. Transition metals include, but are not limited to, scandium, titanium, vanadium, chromium, manganese, iron, cobalt, nickel, copper, zinc, yttrium, zirconium, niobium, molybdenum, technetium, ruthenium, rhodium, palladium, silver, cadmium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, actinium, thorium, protactinium, uranium, neptunium, plutonium, americium, curium, berkelium, californium, einsteinium, fermium, mendelevium, nobelium, and lawrencium.

“Post-transition metals” include, but are not limited to, gallium, indium, tin, thallium, lead, bismuth, or polonium.

As used herein, a battery “successfully operates” in a bent, rolled, or folded configuration if the charge-discharge capacity of the battery in the bent, rolled, or folded configuration is substantially the same as the charge-discharge capacity of the battery before being bent, rolled, or folded (i.e., the original or flat capacity), as measured, e.g., by the output of a device connected to the battery. The bent, rolled, or folded capacity is “substantially the same” as the original or flat charge-discharge capacity if it is within 75% of the original or flat charge-discharge capacity at 0.1 C-rate. As will be known to those of ordinary skill in the art, 0.1, 1, 10, 100, etc. “C-rate” (s) is a term of art well known among those working on characterization of batteries. As used herein, “1 C-rate” means that the constant discharge current will discharge the entire battery in 1 hour, or the constant charge current will charge the battery in 1 hour. As used herein, “0.1 C-rate” means that the current is 10 times smaller, and it will charge/discharge the battery in 10 hours. Practically, first a “theoretical capacity” in A*h (or mA*h) of a battery is calculated based on the amount of the active material in the battery and the material's specific capacity. Then it is divided by the desired number of hours (1 hour for 1 C, 5 hours for 0.2 C, 10 hours for 0.1 C, 0.1 hour for 10 C, etc.), and the charge/discharge current is calculated. The battery charge or discharge capacity is then measured using this current, and this is referred to as the charge or discharge capacity at that C-rate. According to some aspects, the charge-discharge capacity of the battery disclosed herein in a bent, rolled, or folded configuration is from 75 to 100% of the charge-discharge capacity of the battery in a flat configuration.

In some aspects, the battery is in a single cell configuration. FIG. 1A shows a schematic of a battery 100 according to the present disclosure in a single cell configuration. In some such aspects, a first packaging layer 101 is adjacent to an anode layer 102, which is adjacent to a separator layer 103, which is adjacent to a cathode layer 104, which is adjacent to a second packaging layer 101. The anode layer 102 and/or the cathode layer 104 may be configured to include a point of attachment for a battery tab 105 and 106.

In some aspects, the battery is in a multicell configuration. FIG. 1B shows a schematic of a battery 110 according to the present disclosure in a multicell configuration. In some such aspects, multiple alternating layers of anode 102 and cathode 104 are arranged between separator layers 103 and packaging layers 101. Each anode layer 102 and/or cathode layer 104 may be configured to include a point of attachment for a battery tab. For the anode layer 102, the battery tab is suitably a copper tab or lead 105. For the cathode layer 104, the battery tab is suitably an aluminum tab or lead 106. In a multicell configuration, some electrodes in the inner parts of the multi-cell are contacting separator membranes 103 on both sides (FIG. 1B, 3B). The numbers of electrode layers and separator layers in the multicell configuration are not particularly limited, and the multicell configuration battery 110 may contain additional anode, cathode, and/or separator layers than shown in FIG. 1B, as indicated by the optional additional layers 111. Battery 110 may be similar in some aspects to battery 100.

Electrodes according to the present disclosure may be manufactured according to any suitable means known to those of ordinary skill in the art. For example, the anode and/or the cathode may be prepared using the methods and apparatuses disclosed in U.S. patent application Ser. No. 15/665,171, entitled “Self Standing Electrodes and Methods for Making Thereof,” filed Jul. 31, 2017 with attorney docket no. 037110.00687, which is hereby incorporated herein by reference in its entirety. Carbon nanotubes suitable for use in the methods of the present disclosure include single-walled nanotubes, few-walled nanotubes, and multi-walled nanotubes. In some aspects, the carbon nanotubes are single-walled nanotubes. Few-walled nanotubes and multi-walled nanotubes may be synthesized, characterized, co-deposited, and collected using any suitable methods and apparatuses known to those of ordinary skill in the art, including those used for single-walled nanotubes. The carbon nanotubes may range in length from about 50 nm to about 10 cm or greater.

Suitable separator materials include those known to persons of ordinary skill in the art for use in between battery anodes and cathodes, to provide a barrier between the anode and the cathode while enabling the exchange of lithium ions from one side to the other, such as a membranous barrier or a separator membrane. Suitable separator materials include, but are not limited to, polymers such as polypropylene, polyethylene and composites of them, as well as PTFE. The separator membrane is permeable to lithium ions, allowing them to travel from the cathode side to the anode side and back during the charge-discharge cycle. But the separator membrane is impermeable to anode and cathode materials, preventing them from mixing, touching and shorting the battery. The separator membrane also serves as electrical insulator for metal parts of the battery (leads, tabs, current collectors, metal parts of the enclosure, etc.) preventing them from touching and shorting. The separator membrane also prevents flows of the electrolyte.

In some aspects, the separator is a thin (15-25 μm) polymer membrane (tri-layer composite: polypropylene-polyethylene-polypropylene, commercially available) between two relatively thick (20-1000 μm) porous electrode sheets produced by our technology. The thin polymer membrane may be 15-25 μm thick, such as 15-23, 15-21, 15-20, 15-18, 15-16, 16-25, 16-23, 16-21, 16-20, 16-18, 18-25, 18-23, 18-21, 18-20, 20-25, 20-23, 20-21, 21-25, 21-23, 23-25, 15, 16, 17, 18, 19, 20, 21, 22, 23, 24, or 25 μm thick, or any integer or subrange in between. The two relatively thick porous electrode sheets may each independently be 50-500 μm thick, such as 50-450, 50-400, 50-350, 50-300, 50-250, 50-200, 50-150, 50-100, 50-75, 50-60, 50-55, 55-500, 55-450, 55-400, 55-350, 55-300, 55-250, 55-200, 55-150, 55-100, 55-75, 55-60, 60-500, 60-450, 60-400, 60-350, 60-300, 60-250, 60-200, 60-150, 60-100, 60-75, 75-500, 75-450, 75-400, 75-350, 75-300, 75-250, 75-200, 75-150, 75-100, 100-500, 100-450, 100-400, 100-350, 100-300, 100-250, 100-200, 100-150, 150-500, 150-450, 150-400, 150-350, 150-300, 150-250, 150-200, 200-500, 200-450, 200-400, 200-350, 200-300, 200-250, 250-500, 250-450, 250-400, 250-350, 250-300, 300-500, 300-450, 300-400, 300-350, 350-500, 350-450, 350-400, 400-500, 400-450, 450-500, 50, 55, 60, 75, 100, 150, 200, 250, 300, 350, 400, 450, or 500 μm, or any integer or subrange in between.

The polymer used in the polymer pouch cell may be any polymer suitable for use in an electrochemical cell, such as to protect the electrochemical cell from the outside environment or, in the case of a flexible battery used in a wearable device, also to protect the user from the electrochemical cell. As will be known to those of ordinary skill in the art, the pouch cell refers to the external packaging material holding the electrodes and separator(s), and electrolyte inside. Non-limiting examples of suitable materials include those known to those of ordinary skill in the art, such as polyethylene (including polyethylene- or polypropylene-coated aluminum: e.g., Polyamid (JIS Z1714): 0.025 mm (+−0.0025 mm), Adhesive (Polyester-polyurethane): 4-5 g/m2, Aluminum foil (JIS A8079, A8021): 0.040 mm (+−0.004 mm), Adhesive (Urethane-free Adhesive): 2-3 g/m2, Polypropylene: 0.040 mm (+−0.004 mm)), PTFE, PDMS, and others. In the various embodiments disclosed herein, for example, the external packaging material can be flexible, stretchable, twistable, wearable, implantable, biocompatible, without forming creases or wrinkles, waterproof, durable, thermal insulating, or any combination of these features, or any combination with other suitable features depending on the desired application of the battery. According to some aspects, the external packaging material can apply sufficient pressure to electrodes so that the electrodes will stay together inside the packaging without sliding (between the electrodes), peeling, or separating. In some embodiments, sliding of the electrodes inside the external packaging can be provided by the interior surface properties of the external packaging or pouch cell without peeling or separating of the electrodes therein. In a non-limiting example, all the external packaging materials described herein can be a polymer. Non-limiting examples of biocompatible, wearable, and implantable are materials that are not harmful to living tissue, hypoallergenic, or a matrix for living cells/tissue to grow upon. Non-limiting examples of thermal insulating are materials that have low thermal conductivity and can keep heat or cold on one side of the material while keeping transfer of heat or cold through the material minimized.

According to some aspects, the external packaging material can hold a fixed shape after being formed to a fixed shape, or the external packaging material can comprise a shape-memory, as in a non-limiting example, having the ability to return from a deformed shape (temporary shape) to an original (permanent) shape induced by, for example, a temperature change or force applied. In some embodiments, the external packaging material can have an external surface, facing the environment, different than the internal surface, facing the battery. As non-limiting examples, the external surface can have texture or be smooth. The internal surface can have different properties than the external surface, as a non-limiting example, smoothness to enable the battery contained therein to move freely inside the external packaging material or pouch cell if needed. According to some aspects, the external packaging material is multi-layered material or is comprised of various materials at various areas of the pouch cell for different applications. It should be understood the terms “pouch cell” and “flexible pouch” are used interchangeably herein.

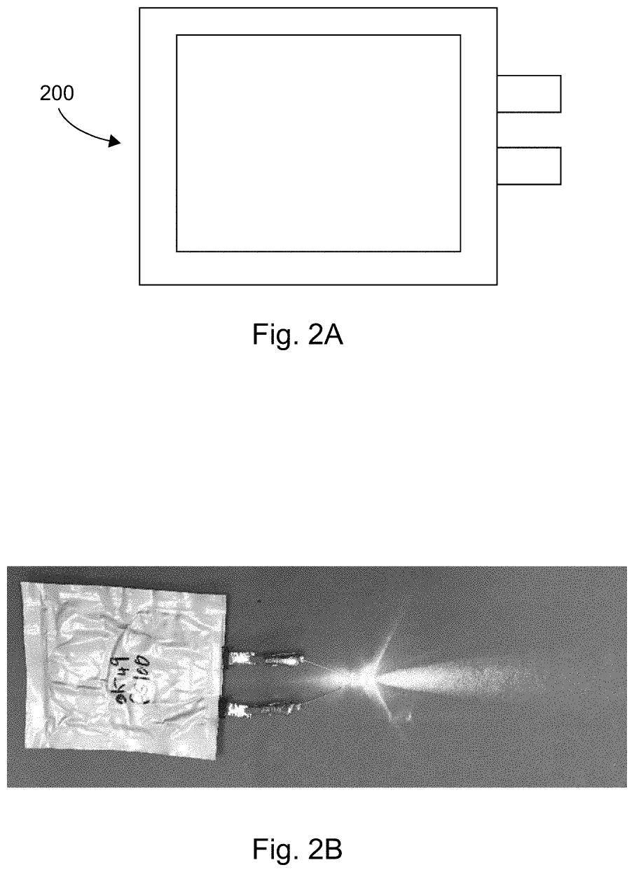

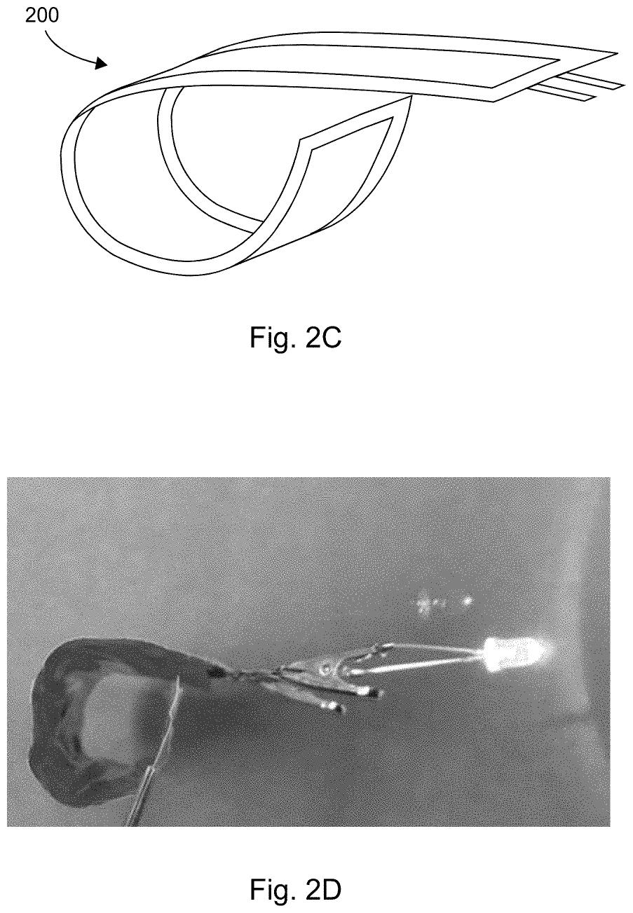

In the various embodiments disclosed herein, the shape of the pouch cell can be, for example, circular, oval, triangular, trapezoidal, a polygon, an ergonomically designed shape, or any shape for the flexible battery disclosed herein applied to various applications. The shape of the pouch cell shown in FIGS. 2A-2D is a non-limiting example. Batteries according to the present disclosure may be assembled using any suitable method, including those known to persons of ordinary skill in the art.

Battery tabs can be attached to the electrodes, in accordance with aspects of the present disclosure, either to protrusions extending from the main body of the respective electrode to past the separator membrane and not overlapping with the other electrode; or to the main body of the respective electrode at cutouts of the separator membrane and the opposing electrode. According to some aspects, the cutouts can be operative to form an exposed area for attachment on the flexible electrode. Suitable battery tab materials and methods of attachment include those known to persons of ordinary skill in the art.

In some aspects, batteries according to the present disclosure are assembled by placing a separator between a fully prepared anode and a fully prepared cathode without any further repressing. As used herein, a “fully prepared” anode or cathode is one that has been pressed and attached to a tab. In some aspects, batteries according to aspects of the present disclosure are assembled by placing a separator between a pre-pressed anode and a pre-pressed cathode, and pressing them all together. As used herein, a “pre-pressed” electrode is one that has been pressed but may or may not be attached to a tab or have embedded within a tab attachment. In some aspects, the battery can be assembled by placing a separator between one un-pressed first electrode (anode or cathode) and a pre-pressed electrode (anode or cathode), and the whole assembly can be pressed together.

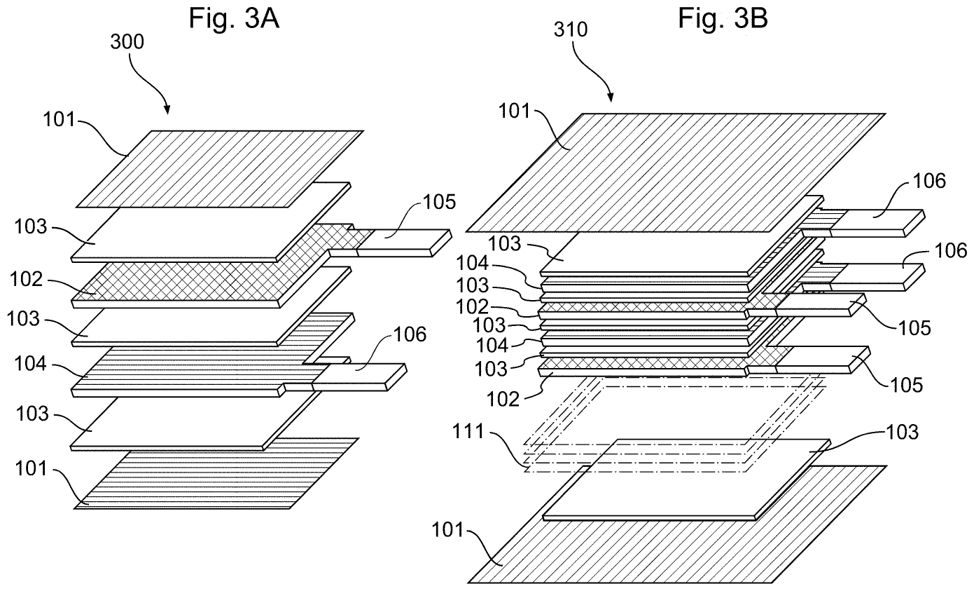

Preferably, the concentration of carbon nanotubes, or carbon nanotube content, on the surfaces of the electrodes facing the separator is higher (5-100 wt % of nanotubes) than that in the bulk of the electrodes (0.5-10 wt % of nanotubes), while the concentration of carbon nanotubes on the surfaces of the electrodes facing away from the separator is lower (0-1 wt % of nanotubes) than that in the bulk of the electrodes (FIGS. 3A-3B). According to some aspects, the 0.5-10 wt % of nanotubes in the bulk of the electrodes can be 0.5-10 wt % at a central plane or central longitudinal plane of the flat electrodes. Composite material comprising more than about 5% of nanotube is considered by those of ordinary skill in the art to be very sticky, and will stick to separator membrane and to stainless steel (which is a typical material that the rollers of the roller mills are made of) as well as to many other materials. For example, a composite material comprising 5% nanotube, 95% NMC (Lithium Nickel Manganese Cobalt Oxide, LiNiₓMn_{y}Co_{z}O₂) (especially when freshly made) sticks to the rollers so well, that it is difficult to separate it from the rollers without tearing the composite. However, the same material “dusted” with NMC powder will not stick to the rollers in any appreciable amount. These “border layers” may be 2-5 times thicker than the average size of the active material particle/flake; e.g., for NMC particles used in a cathode, with an average diameter of about 10 μm, 20-30 μm thick “border layers” with increased or decreased nanotube content may be sufficient. In accordance with aspects of the present disclosure, this distribution of carbon nanotubes on or within the electrodes will promote adhesion of electrodes to the separator membrane, while reducing the adhesion to the rollers and other elements of the pressing apparatus (for pressed electrodes and pressed batteries). This distribution can be achieved by varying the ratio(s) of the nanotube aerosol to the active material aerosol(s) (i.e., the ratio of the weight of nanotubes deposited per unit time to the weight of the active material deposited per the same unit time) during the growth of electrode material (e.g., 100% active material aerosol at the beginning of the synthesis, 97% active material aerosol, and 3% nanotube aerosol during most of the synthesis, and 100% nanotube aerosol during the end of the synthesis). For example, according to the present disclosure, a nanotube synthesis reactor may be configured to produce about 2 mg of aerosolized nanotubes per hour (the amount deposited on the frit/filter). In the same setup the NMC feeder may be set to aerosolize from about 2 to 600 mg of NMC particles per hour (again, the amount deposited on the same filter). Therefore, depending on the settings on the NMC feeder, it is possible to deposit material containing from 50% nanotubes (2 mg+2 mg) to about 0.3% nanotubes (2 mg+600 mg). Operating only nanotube reactor (NMC feeder off) produces 100% nanotube material, while operating only NMC feeder (nanotube reactor off) produces 0% nanotube material (NMC powder). Suitable methods of varying ratios of nanotube aerosol and active nanotube aerosol(s) during growth include, but are not limited to, those disclosed in U.S. patent application Ser. No. 15/665,171, entitled “Self Standing Electrodes and Methods for Making Thereof,” filed Jul. 31, 2017, which is hereby incorporated herein by reference in its entirety.

The battery may be of any size, i.e., of any length, width, and height. In some aspects, the thickness of the battery is less than or equal to 10 mm, such as 5 mm, 4.5 mm, 3 mm, 2.5 mm, 1.5 mm, 1 mm, 0.7 mm, 0.5 mm, 0.3 mm, 0.2 mm, 0.1 mm, 0.01 mm or any value or range in between. In some aspects, the length and width are each independently less than or equal to 10000 mm, such as 1000 mm, 200 mm, 150 mm, 100 mm, 75 mm, 50 mm, 40 mm, 30 mm, 25 mm, 20 mm, 10 mm, 1 mm, 0.5 mm, 0.1 mm or any value or range in between.

FIGS. 2A-2D show an example of a battery according to the present disclosure connected to an LED device. In this non-limiting example, the complete pouch battery cell contains 3×4 cm electrodes and is connected to a LED device. The battery thickness is 3 mm. In the flat configuration (FIGS. 2A-2B), the battery 200 operates to power the LED device, as measured by the output of light from the device. After multiple instances of bending at various angles and in various directions, while powering the LED device, the battery 200 was still able to power the LED device to emit light in the rolled configuration (FIGS. 2C-2D). Battery 200 may be similar in some aspects to battery 100.

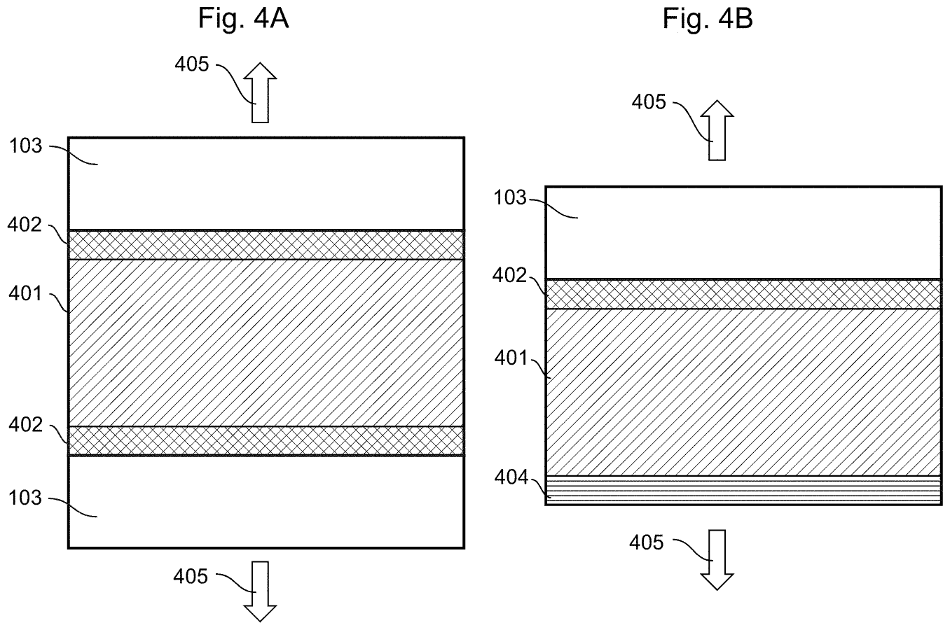

For batteries 300 in a configuration as shown in FIG. 3A, where all electrodes (e.g., anode 102 and cathode 104 in FIG. 3A), as well as inner electrodes 102 and 104 of the battery 310 in the multi-cell configuration shown at FIG. 3B, are contacting separator membranes 103 on both sides, it is beneficial to have the increased nanotube content 402 (in the electrode) on both surfaces of the electrode (i.e., on both faces of anode 102, both of which are in contact with a separator membrane 103, and on both faces of cathode 104, both of which are in contact with a separator membrane 103) (FIG. 4A). In FIG. 4A, the center of the electrode contains the bulk of the electrode material 401, which contains 0.5-10 wt % of nanotubes. Moving outward from the electrode center toward the separator membrane 103, band 402 contains electrode material with increased nanotube content, such as 5-100 wt % of nanotubes. Band 402 contacts separator membrane 103 on its outer edge, and separator membrane 103 extends away from the side facing band 402 to the side facing towards a roller or press in manufacturing, in direction 405. Batteries 300 and 310 may be similar in some aspects to battery 100.

The difference between FIGS. 3A-3B and FIGS. 1A-1B is that extra separator membrane layers 103 are added on both outer sides of the cell (both single-cell or multi-cell configurations), to improve mechanical integrity of the cell and to allow better sliding of the cell in respect to packaging. This extra layer of the separator membrane 103 can even be wrapped around the assembled cell. All electrodes of the batteries shown at FIGS. 3A and 3B (both single-cell or multi-cell configurations) will be in the configuration shown at FIG. 4A, while outer electrodes of the batteries shown at FIGS. 1A-1B will be in the configuration shown at FIG. 4B. In FIG. 4B, the outer face of separator membrane 103 faces in direction 405, toward a roller or press, and the inner face faces band 402 of the electrode, which has an increased nanotube content, such as 5-100 wt % of nanotubes. Continuing inward across band 402, the opposite face of band 402 faces region of bulk electrode material 401, containing 0.5-10 wt % of nanotubes. The opposite face of region of bulk electrode material 401, in turn, faces a region of reduced nanotube content 404, containing 0-1 wt % of nanotubes. Moving even further inward, the opposite face of region of reduced nanotube content 404 faces inward in direction 405 towards a roller or press.

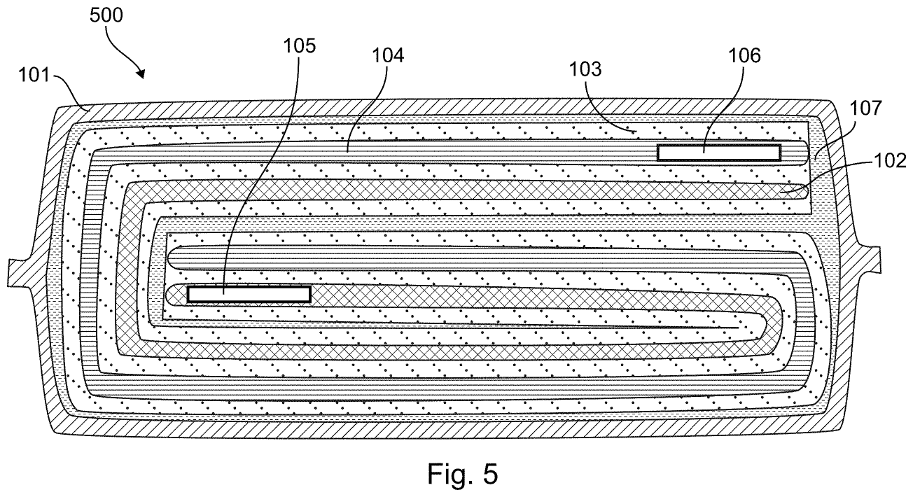

The cell assembly according to the present disclosure (i.e., the anode, the separator, and the cathode in a single-cell configuration; or the alternating layers of a separator layer, one or more anodes, one or more separators, and one or more cathodes in a multi-cell configuration) may be encapsulated in a pouch cell either flat (i.e., as shown in FIGS. 1A, 1B, and 2A) or folded one or more times prior to encapsulation in a pouch cell (as shown in FIG. 5). In pouch cell battery 500, a battery containing layers of separator membrane 103, anode 102, separator membrane 103, cathode 1-4, and separator membrane 103 is folded one or more times before being encapsulated by a pouch cell made of a packaging layer 101. An electrolyte 107 is also suitably included in the pouch cell during encapsulation. The anode layer 102 and cathode layer 104 may each be configured to include a point of attachment for a battery tab. For the anode layer 102, the battery tab is suitably a copper tab or lead 105. For the cathode layer 104, the battery tab is suitably an aluminum tab or lead 106. Battery 500 may be similar in some aspects to battery 100. In some embodiments, further battery tab extensions can be attached to 105 and/or 106.

Encapsulation in a pouch cell, such as in packing layer 101, after prior folding may increase battery capacity but may also reduce battery flexibility. In the folded configuration, one or more additional separator membranes may be required to prevent the electrodes from touching each other (or to prevent any of their electrical leads from touching each other). In some such aspects, it may be beneficial to include one or two extra layers of separator membrane, such that the multi-cell configuration alternates as shown in FIGS. 3A-3B, in part: separator 103, anode 102, separator 103, cathode 104, separator 103. Such assembly not only simplifies the folded configuration shown in FIG. 5, but also makes the battery mechanically stronger, allowing it to withstand additional bending, folding, rolling, flexing, and/or wear and tear; because the added separator layers facilitate sliding the cell assembly into the pouch cell, and, even more importantly, allows the cell assembly to slide as a whole in respect to packaging/encapsulation during bending, folding, flexing, etc. with minimal movement of the cell components in respect to each other. Such movements of the internal cell components in respect to each other can be detrimental to the cell performance. It is preferable for this configuration for the electrode (cathode or anode or both) material to have increased nanotube concentration on both faces, i.e., both faces of the electrode that contact a separator membrane. With an increased concentration of nanotubes at the electrode faces, the electrode will stick well to both separator membranes, thereby facilitating assembly and/or pressing of the whole 5-layer cell assembly, since only separator membrane(s) would touch rollers or other equipment. In the case where only one extra separator membrane is used, then the electrode material face that does not contact or face a separator membrane preferably has a reduced nanotube content on the face not contacting a separator membrane.

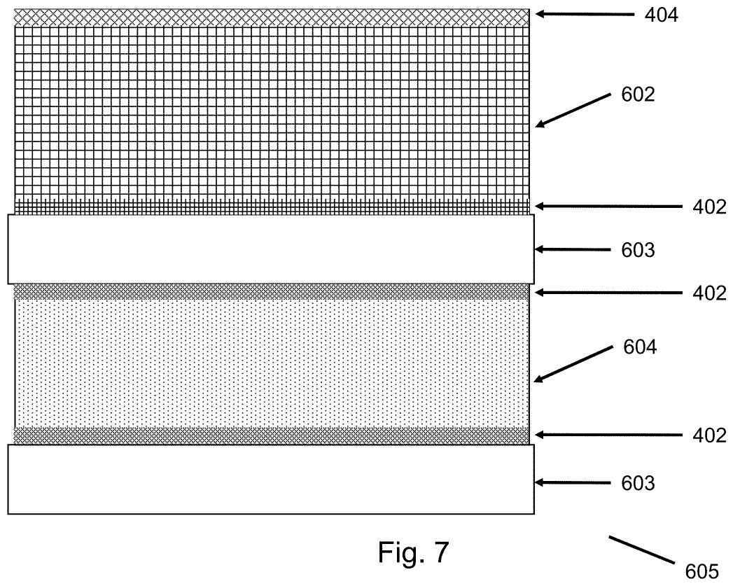

According to some aspects, natural adhesion of nanotubes is utilized to attach the flexible self-standing electrodes to a separator membrane (or a flexible solid electrolyte sheet). This natural adhesion effect can be further enhanced by increasing nanotube content on the surface of the electrode facing the separator membrane as illustrated in FIGS. 4A-4B, and FIG. 7. This is an important aspect for a flexible battery, wherein electrode separation is one of the main mechanisms for battery performance deterioration, especially during flexing of the battery. As used herein, “natural adhesion” refers to the ability for one material to stick to another without added adhesive or binder. Composite material comprising more than about 5% (weight %) of nanotube is considered by those of ordinary skill in the art to be very sticky, and will stick to a separator membrane and to stainless steel (which is a typical material that the rollers of the roller mills are made of) as well as to many other materials. For example, a composite material comprising 5% nanotube, 95% NMC (Lithium Nickel Manganese Cobalt Oxide, LiNixMnyCo_{z}O₂) (especially when freshly made) sticks to rollers so well, that it is difficult to separate it from the rollers without tearing the composite. According to some aspects, undesirable adhesion of the flexible self-standing electrodes to some surfaces, for example rollers of a roll mill or surfaces of a press, is avoided or minimized by reducing the nanotube content on the surfaces facing the rollers (FIGS. 4B, 7, areas of low nanotube content). For example, if an electrode sticks to a roller, the electrode can be destroyed. In some embodiments, “as-grown” electrode material can need to be pressed both to increase material mechanical properties and to reduce material porosity, therefore reducing required electrolyte volume, thus increasing energy density of the battery.

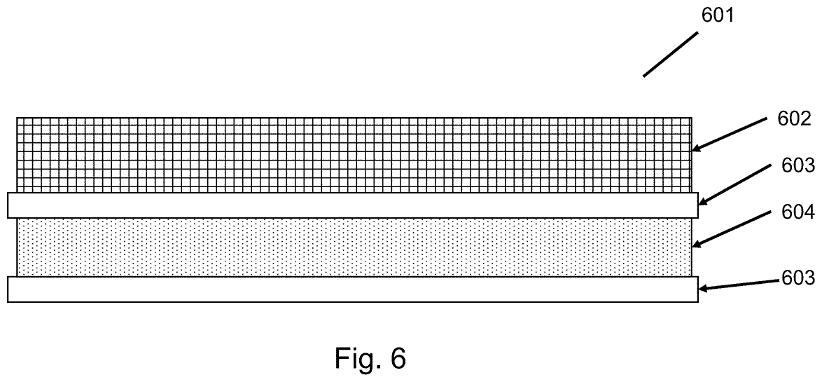

In some embodiments, the cell (for example, a cathode-separator-anode “sandwich”) can be assembled either from pre-pressed cathode and pre-pressed anode by placing a separator membrane between them or by pressing one or both electrodes directly onto the separator membrane (or a solid electrolyte sheet), increasing adhesion of the electrodes to the membrane and combining two operations in one. According to some aspects, a separator membrane on one or both sides of an electrode (FIG. 4A) can also serve as the “non-stick” layer during the pressing procedure, and in this case, increased nanotube content is beneficial on both sides of the electrode (FIG. 4A). In some embodiments, attaching a separator membrane on both sides of an electrode (FIG. 4A) enables multi-cell and folded cell configurations, when the opposite electrode (e.g., anode) is on both sides of this electrode (e.g., cathode), to prevent opposing electrodes touching and shortening. In some embodiments, a preferred stacking scheme for multi-cell and folded embodiments is shown in FIG. 6 as 601. As shown in FIG. 6, 602 represents a cathode while 603 represents a separator and 604 represents an anode. The 602 (cathode) and 604 (anode) can be switched. The stacked scheme 601 can be rolled together. In some embodiments, a preferred stacking scheme for multi-cell and folded embodiments is shown in FIG. 7 as 605. As shown in FIG. 7, 404 represents a reduced or minimized nanotube content zone, for example, to avoid undesirable adhesion of the flexible self-standing electrodes to some surfaces, for example rollers of a roll mill or surfaces of a press. A cathode 602 is shown with an increased nanotube content zone 402 near the separator 603 and an anode 604 is shown with two increased nanotube content zones 402 near separators 603. For example, in FIG. 7, the cathode and the anode can be switched and the configuration 605 can be rolled together.

In some embodiments, to attach a battery tab to an electrode encapsulated with a separator membrane on both sides, the electrode can have an embedded tab attachment as exemplified in U.S. patent application Ser. No. 16/123,872, entitled “Method for Embedding a Battery Tab Attachment in a Self-Standing Electrode Without Current Collector or Binder”, filed Sep. 6, 2018, protruding past the edge of the separator membrane, or the electrode itself can have protrusions past the edge of the separator membrane, and the tab is attached to the protrusions of the electrode as in U.S. patent application Ser. No. 16/123,935, entitled “Method for Battery Tab Attachment to a Self-Standing Electrode”, filed Sep. 6, 2018. Such battery tab attachment sites should not overlap each other to prevent shorting, or an extra section of the separator membrane can be added between them. In some embodiments, the electrodes can contain embedded battery tab attachments, for example, as described in U.S. patent application Ser. No. 16/123,872, protruding past the edge of the separator membrane. For example, a strip of metal foil, mesh or netting can be embedded into the electrode material during electrode material deposition as described in U.S. patent application Ser. No. 16/123,872, with a part of the strip extending past the edge of the electrode and optionally past the edge of the separator membrane. In some embodiments, either a pre-fabricated tab can be welded or attached to the protruding part of the strip, or the strip itself can be long enough to extend past the enclosure of the battery, and serve as the tab to carry electrical current out of the battery. In the latter case care should be taken to exclude leaks in the area where the strip/tab crosses the battery enclosure. For example, pre-fabricated tabs typically have some sealant material deposited on them for this purpose.

According to some aspects, battery tab extensions can be attached to the battery tabs on, within, or embedded in the electrodes. Attachment can be, for example, by soldering, welding, pre-manufactured interlocking parts, or by any means known in the art. In some embodiments, the battery tab extensions can extend past the flexible pouch to provide electrical current to various devices. To prevent any leakage at areas where battery tabs or battery tab extensions extend through and out of the flexible pouch, a joint or sealant can be utilized to seal the areas. In some aspects, the durability of the flexible lithium ion battery is maintained throughout bending into various configurations over time by sealing or joints. In various embodiments, battery tab extensions can comprise flexible conductive materials.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

According to some aspects, a flexible lithium ion battery is disclosed herein comprising: an electrolyte; one or more electrodes comprising: one or more flexible anodes containing carbon nanotubes; one or more flexible cathodes containing carbon nanotubes; and one or more flexible separator membranes positioned between the one or more flexible anodes and one or more flexible cathodes; to form a battery; and wherein the battery is inside a flexible pouch, the flexible pouch comprising an external packaging material operative to hold the battery inside. In some embodiments, one or more electrodes further comprise a battery tab attached to at least one of a respective protrusion extending from a main body of one or more electrodes past a separator membrane, or to the main body of one or more electrodes at cutouts of a separator membrane and one or more opposing electrodes. The concentration of carbon nanotubes on a surface of a respective electrode facing and in contact with a separator membrane can be 5-100 wt % of carbon nanotubes, the concentration of carbon nanotubes in the bulk of an electrode can be 0.5-10 wt % of carbon nanotubes, and the concentration of carbon nanotubes on the surface of a respective electrode facing away from a separator membrane and not in contact with a separator membrane can be 0-1 wt % of carbon nanotubes.

According to some aspects, a method of making a flexible lithium ion battery is disclosed herein comprising: providing one or more electrodes, each containing one or more surfaces containing 5-100 wt % of carbon nanotubes; providing one or more separator membranes; placing one or more separator membranes between one or more electrodes, the one or more separator membranes in contact with the one or more surfaces containing 5-100 wt % of carbon nanotubes, to form a battery; and placing the battery inside a flexible pouch, the flexible pouch comprising an external packaging material operative to hold the battery inside. In some embodiments, the method can further comprise the surfaces of the one or more electrodes not in contact with the one or more separator membranes contain 0-1 wt % of carbon nanotubes, the 0-1 wt % of carbon nanotubes operative to provide one or more non-adherent surfaces. In some embodiments, the method can further comprise placing one or more separator membranes on the surfaces of one or more electrodes not between one or more electrodes, such that one or more separator membranes are on one or more outer surfaces of one or more electrodes. According to some aspects, a method of making a flexible self-standing electrode comprising: collecting a 5-100 wt % concentration of carbon nanotubes; collecting a 0.5-10 wt % concentration of carbon nanotubes; and collecting a 0-1 wt % concentration of carbon nanotubes, to form a flexible self-standing electrode comprising 5-100 wt % of carbon nanotubes on a first outer surface, a 0.5-10 wt % concentration of carbon nanotubes in the bulk, and a 0-1 wt % concentration of carbon nanotubes on a second outer surface.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

The examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, dimensions, etc.) but some experimental errors and deviations should be accounted for.

Moreover, all references throughout this application, for example patent documents including issued or granted patents or equivalents; patent application publications; and non-patent literature documents or other source material; are hereby incorporated by reference herein in their entireties, as though individually incorporated by reference.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative aspects of the disclosure when read in conjunction with the accompanying drawings, wherein:

What is claimed is:

1. A flexible lithium ion battery comprising:
an electrolyte comprising a liquid, gel, solid, or a combination thereof;
one or more electrodes comprising:
one or more flexible anodes comprising composite material comprising anode active material particles in a three-dimensional cross-linked network of carbon nanotubes;
one or more flexible cathodes comprising composite material cathode active material particles in a three-dimensional cross-linked network of carbon nanotubes; and
one or more flexible separator membranes positioned between the one or more flexible anodes and the one or more flexible cathodes; to form a battery; and
wherein the battery is inside a flexible pouch, the flexible pouch comprising an external packaging material operative to hold the battery inside.

2. The battery of claim 1, wherein the battery is free of current collector.

3. The battery of claim 1, wherein the battery is free of binder.

4. The battery of claim 1, in which one or more electrodes further comprise a battery tab attached to at least one of a respective protrusion extending from a main body of one or more electrodes past a separator membrane, or to the main body of one or more electrodes at cutouts of a separator membrane and one or more opposing electrodes.

5. The battery of claim 1, wherein the external packaging material comprises a flexible material, a stretchable material, a twistable material, a wearable material, an implantable material, a biocompatible material, a wrinkle-free material, a waterproof material, a durable material, a thermally insulating material, and any combinations and layers thereof.

6. The battery of claim 1, wherein the concentration of carbon nanotubes on a surface of a respective electrode facing and in contact with a separator membrane is 5-100 wt % of carbon nanotubes, the concentration of carbon nanotubes in the bulk of an electrode is 0.5-10 wt % of carbon nanotubes, and the concentration of carbon nanotubes on the surface of a respective electrode facing away from a separator membrane and not in contact with a separator membrane is 0-1 wt % of carbon nanotubes.

7. The battery of claim 4, wherein two or more battery tabs extends past the flexible pouch, the two or more battery tabs operative to provide an electrical current outside the flexible pouch.

8. The battery of claim 4, further comprising two or more battery tab extensions extending past the flexible pouch, the two or more battery tab extensions each attached respectively to a battery tab.

9. The battery of claim 1, wherein the battery is folded along the length or along the width one or more times inside the flexible pouch.

10. The flexible lithium ion battery of claim 1, wherein the charge-discharge capacity of the flexible lithium ion battery in a bent, rolled, or folded configuration is from 75 to 100% of the charge-discharge capacity of the flexible lithium ion battery in a flat configuration.

11. The flexible lithium ion battery of claim 1, wherein the anode active material particles comprise graphite, silicon, natural graphite, artificial graphite, activated carbon, carbon black, high-performance powdered graphene, or combinations thereof; and the cathode active material particles comprise a lithium metal oxide, metal lithium, (LiNiₓMn_{y}Co_{z}O₂, x+y+z=1), Li(Ni,Mn,Co)O₂, Li—Ni—Mn—Co—O, or combinations thereof.

12. A method of making a flexible lithium ion battery comprising:
providing one or more electrodes, each containing one or more surfaces containing 5-100 wt % of carbon nanotubes;
providing one or more separator membranes;
placing one or more separator membranes between one or more electrodes, the one or more separator membranes in contact with the one or more surfaces containing 5-100 wt % of carbon nanotubes, to form a battery; and
placing the battery inside a flexible pouch, the flexible pouch comprising an external packaging material operative to hold the battery inside.

13. The method of claim 12, wherein the 5-100 wt % of carbon nanotubes is operative to adhere to the one or more separator membranes.

14. The method of claim 12, further comprising the surfaces of the one or more electrodes not in contact with the one or more separator membranes contain 0-1 wt % of carbon nanotubes, the 0-1 wt % of carbon nanotubes operative to provide one or more non-adherent surfaces.

15. The method of claim 14, further comprising pressing one or more electrodes by contacting one or more surfaces containing 0-1 wt % of carbon nanotubes.

16. The method of claim 14, further comprising placing one or more separator membranes on the surfaces of one or more electrodes not between one or more electrodes, such that one or more separator membranes are on one or more outer surfaces of one or more electrodes.

17. The method of claim 16, further comprising pressing one or more electrodes by contacting one or more separator membranes on one or more outer surfaces of one or more electrodes.

18. The method of claim 12, further comprising attaching one or more battery tabs attached to at least one of a respective protrusion extending from a main body of one or more electrodes past the separator membrane, or to the main body of one or more electrodes at cutouts of one or more separator membranes and the opposing electrode.

19. A method of making a flexible self-standing electrode comprising:
collecting a 5-100 wt % concentration of carbon nanotubes;
collecting a 0.5-10 wt % concentration of carbon nanotubes; and
collecting a 0-1 wt % concentration of carbon nanotubes, to form a flexible self-standing electrode comprising 5-100 wt % of carbon nanotubes on a first outer surface, a 0.5-10 wt % concentration of carbon nanotubes in the bulk, and a 0-1 wt % concentration of carbon nanotubes on a second outer surface.

20. The method of claim 19, further comprising attaching a separator membrane to the first outer surface comprising 5-100 wt % of carbon nanotubes, the 5-100 wt % of carbon nanotubes operative to adhere to the separator membrane.

21. The method of claim 20, further comprising pressing the flexible self-standing electrode with a pressing apparatus, the separator membrane and the 0-1 wt % concentration of carbon nanotubes operative to prevent adhesion of the electrode to the pressing apparatus.
